(19) United States
(12) Patent Application Publication
(10) Pub. No.: US 2013/0105312 A1
(43) Pub. Date: May 2, 2013

(54) DIAMOND MICROELECTRODE

(71) Applicants: Kevin John Oliver, Dorchester (GB); Arnaldo Galbiati, West Drayton (GB); Stephen Charles Lynn, Dorchester (GB)

(72) Inventors: Kevin John Oliver, Dorchester (GB); Arnaldo Galbiati, West Drayton (GB); Stephen Charles Lynn, Dorchester (GB)

(73) Assignee: Element Six Limited, London (GB)

(21) Appl. No.: 13/641,146

(22) PCT Filed: Apr. 14, 2011
(86) PCT No.: PCT/EP2011/055967

§ 371 Date: Jan. 18, 2013

(30) Foreign Application Priority Data
Apr. 16, 2010 (GB) 1006359.2

(51) Int. Cl. G01N 27/30

(52) U.S. Cl. CPC G01N 27/308
USPC 204/400; 427/113; 427/555; 216/13

(57) ABSTRACT

A microelectrode for electrochemical analysis having an analysis surface which comprises one or more regions of electrically conductive diamond material surrounded by electrically insulating diamond-like carbon material, the diamond-like carbon material having, (a) a hardness lower than that of the electrically conductive diamond material and (b) a resistivity of at least 1×10⁹ ohm·cm, and the microelectrode being provided with connection means (10) for electrically connecting the one or more regions to an external circuit.

### FIELD OF THE INVENTION

The present invention relates to microelectrodes and to sensors and other electrochemical devices which contain them.

### BACKGROUND OF THE INVENTION

It is known to make microelectrodes for use in electrochemical sensing. A non-conducting layer is provided over a conductive electrode material leaving small areas of the conductive material exposed which can be brought into contact with the fluid to be sensed. Typically the conductive material has been a metal, but more recently boron-doped diamond has been used. For example, P Rychen et al disclose applying a layer of Si₃N₄ or similar non-conductive material to the surface of boron doped diamond and subsequently etching apertures into it to expose the diamond underneath (Electrochemical Society Proceedings vol 2001-23 pp 97-107).

JP2009-128041 discloses a three-dimensional diamond microelectrode array.

WO 2005/012894 A1 discloses a microelectrode in which pins or projections of electrically conducting diamond extend at least partially through a layer of non-conducting diamond so as to provide the conductive points on the analysis surface of a microelectrode. WO 2005/017514 A1 discusses the use of a similar microelectrode in sensors for monitoring the characteristics of a fluid such as those associated with wellbores.

While such a diamond microelectrode is effective and reliable, it is costly to manufacture, requiring layers of both conducting and non-conducting diamond to be grown which requires a specialist manufacturer.

There remains a need for a diamond microelectrode which is resilient and reliable but more easily and cheaply produced.

### SUMMARY OF THE INVENTION

In accordance with the present invention there is provided a microelectrode having an analysis surface which comprises one or more regions of electrically conductive diamond material surrounded by electrically insulating diamond-like carbon material, the diamond-like carbon material having,

(a) a hardness lower than that of the electrically conductive diamond material and
(b) a resistivity of at least 1×10⁹ ohmcm,
and the microelectrode being provided with connection means for electrically connecting the one or more regions to an external circuit.

Microelectrodes produced according to the present invention have the advantage that they are very stable and resilient because diamond-like carbon material adheres well to diamond material and has very similar physical properties such as thermal expansion coefficient. They are easier and cheaper to produce than existing microelectrodes such as those described in WO 2005/012894 because diamond-like carbon is relatively easy to deposit and does not require such specialist equipment and conditions. Further both diamond and diamond-like carbon are biocompatible so can be used for sensing applications inside the body.

The microelectrodes of the present invention make use of electrically insulating diamond-like carbon material. Such materials have recently been developed and can be made with a varying range of physical properties according to the specific process conditions used for their fabrication, see e.g. research carried out at Brunel University, www.etcbrunel.co.uk/research_files/DLC.htm. Diamond is a crystalline material in which the carbon atoms are tetrahedrally arranged and bonded to each other with sp³ bonds, diamond-like carbon material on the other hand contains both tetrahedral sp³ bonded and graphitic sp² bonded carbon atoms, shows no long range order and may have significant amounts of hydrogen present. It can be deposited as a thin film coating that has useful properties being dense, inert, low friction and hard wearing.

Hitherto diamond-like carbon material has generally been used as a competitor material for diamond exploiting its diamond-like properties so it can be used as an alternative to diamond for some applications. Here, on the other hand, the present inventors are surprisingly combining diamond together with diamond-like carbon using properties of both materials to produce a new product.

For the purposes of the present invention the diamond-like carbon material should have a hardness less than that of the electrically conductive diamond. Diamond typically has a Vickers hardness of about 85 to 100 GPa (by definition it has a hardness of 10 on the Moh's scale). The diamond-like carbon material used in the present invention may typically have a hardness of 20 to 80 GPa. Where the method of fabricating the microelectrode is to include an abrasion step as discussed below, the diamond-like carbon may typically have a hardness of 60 GPa or less. For example, it may have a hardness of 0.75 or less times the hardness of the conductive diamond, alternatively between 0.55 and 0.65 times, alternatively less than or equal to 0.6 times.

The electrically insulating diamond-like carbon material will have a resistivity of at least 1×10⁹ ohmcm. In practice the resistivity may be higher than this, for example it may be at least 1×10¹⁰, alternatively at least 1×10¹¹ ohmcm or even more than 1×10¹² ohmcm.

The person skilled in the art will understand that the particular electrically insulating diamond-like carbon material selected for use in a microelectrode according to the present invention will be one with physical properties such as to combine durability with ease of manufacture. Typically the electrically insulating diamond-like carbon material may have a density in the range 2.0 to 2.7 g/cm³, alternatively 2.2 to 2.6 g/cm³, alternatively 2.3 to 2.5 g/cm³. The density of natural diamond has been reported to be in the range 3.15 to 3.53 g/cm³, and is typically about 3.5 g/cm³, while that of synthetically produced electrically conductive diamond is likely to be in the region of 3.5 g/cm³.

One of the useful properties of the diamond-like carbon material is that when it is deposited on to electrically conductive diamond material a strong bond is formed between the two materials. This means that a microelectrode comprising such layers has little tendency to delaminate during use. Further, the bonds remain stable at elevated temperatures up to 400° C. before the diamond-like carbon material starts to oxidise.

The electrically conductive diamond material may be doped diamond, for example boron doped diamond, or diamond doped with another element that confers conductivity such as phosphorus. The electrically conductive diamond material may be naturally conductive diamond but in practice is likely to be synthetic diamond grown by a conventionally known process such as a high pressure high temperature process or a chemical vapour deposition process. The electrically conductive diamond material may either polycrystalline or single crystal diamond material. Chemical vapour deposition can be used to grow doped single crystal diamond having very controllable conductivity through the bulk of the material, so where it is desired to use diamond material having such properties this is a convenient source. Other methods for producing conductive diamond include doping by ion implantation. The electrically conductive diamond material for use in the present invention may for example have a resistivity less than 1×10³ ohmcm, alternatively less than 10 ohmcm, alternatively, 1 ohmcm or less. Typically it will have a resistivity in the range 0.05 to 1 ohmcm.

Microelectrodes used in electrochemistry utilise the relationship between current and voltage measured when immersed in a fluid to characterise properties of the fluid. The fluid may be a liquid, or a gas, and is typically a solution. Dependent on the application, one of the current or voltage may be fixed and the other parameter allowed to vary, for example as the composition of the solution varies. Alternatively the solution may be fixed and one of the current or voltage may be swept across a range of values and the response in the other parameter recorded in the form of a plot of time versus current, time versus voltage or voltage versus current (e.g. a cyclic voltammogram).

Electrochemical measurements can be qualitative or comparative, or they may be quantitative. Quantitative measurements generally require that the system is amenable to mathematical modelling, and in both cases it is desirable that the signal to noise ratio in the system is maximised and that as much information as possible is extracted from the system, see Feeney R and Kounaves S P, “Microfabricated ultramicroelectrode arrays: developments, advances, and applications in environmental analysis”, Electroanalysis 2000, 12 no. 9 pages 677-684. These objectives can best be achieved by using small electrode points.

The microelectrode according to the present invention has an analysis surface which comprises one or more regions of electrically conductive diamond material surrounded by electrically insulating diamond-like carbon material which provide the electrode points. These may conveniently present a circular profile on the analysis surface, but it will be understood that other shapes may be used dependent on the method of fabrication and intended application. Where the diameter of the regions is fairly small, species in the solution will diffuse under an applied electric field towards the regions according to an approximately hemispherical three-dimensional diffusion model. The diameter of the regions may, for example, range from 1 μm to 200 μm, typically the diameter of the regions may be in the range 10 μm to 50 μm, alternatively 15 μm to 30 μm.

The simplest analysis surface according to the present invention will comprise only one region of electrically conductive diamond material. However, to increase the signal to noise ratio it may be desirable to use an analysis surface with two or more regions of electrically conductive diamond material surrounded by electrically insulating diamond-like carbon so as to provide two or more electrode points. The regions of electrically conductive diamond material will be electrically connected to each other at a position away from the analysis surface. Where the microelectrode is formed by deposition of a layer of diamond-like carbon material on to a substrate of electrically conductive diamond material, as described below, it will be understood that the regions will be electrically connected together by the substrate of electrically conductive diamond material. Further, that substrate may then provide connection means for electrically connecting the regions to an external circuit.

If desired the analysis surface will comprise an array of three or more electrode points. In practice, the array may contain many more electrode points, depending on the intended application. The electrode points may conveniently each have a diameter in the range 15 μm to 30 μm and be separated from nearest neighbours by a distance of 5 to 15 times the average diameter of the electrode points. This geometry facilitates an efficient three dimensional diffusion model with, in use, each electrode point being surrounded by a hemispherical diffusion volume.

The array of electrode points may be electrically connected together through the substrate of electrically conductive diamond material which acts as connection means for electrically connecting the array to an external circuit. The external circuit can be electrically connected to the substrate by a variety of means. For example, contact pads could be provided on an exposed surface of the electrically conductive substrate onto which individual wire bonds may be made or to which a ball-grid array substrate may be soldered. Alternatively, a metallised layer may be provided over the exposed surface and bonds made to that layer.

According to the present invention it is also possible to manufacture a microelectrode which has an analysis surface which is subdivided into two or more arrays which are electrically separated from each other and adapted to connect to separate external circuits. Where the microelectrode is formed by deposition of a layer of diamond-like carbon material on to a substrate of electrically conductive diamond material, as described below, the electrical separation may be arranged by suitable geometry of the substrate of electrically conductive diamond material. For example a groove may be cut through the substrate of conductive material from below to separate it into two electrically separate portions each of which contains an array of electrically connected electrode points. Separate external circuits may then be connected to these separate portions. It will be understood that by suitable choice of geometry of electrode points and rear grooving it is possible to subdivide a microelectrode into any desired number of separately addressable arrays.

It will be understood that the microelectrode described, including any additional bonding wires and contact pads, may be exposed to the fluid under analysis as it is or the structure may be fitted into an electrode holder, such as a polytetrafluoroethylene tube, or by some other means packaged to protect the structures behind the analysis surface before use.

In a first embodiment the microelectrode of the present invention comprises a layer of electrically insulating diamond-like carbon material deposited on a substrate of electrically conductive diamond material, the substrate of electrically conductive diamond material having one or more protrusions projecting through the layer of diamond-like-carbon material so as to provide the one or more regions of electrically conductive diamond material for the analysis surface. In this embodiment the diamond-like carbon layer may typically have a thickness in the range 5 μm to 10 μm.

In a second embodiment the analysis surface for the microelectrode of the present invention is provided by a layer of electrically insulating diamond-like carbon material deposited on a substrate of electrically conductive diamond material, the layer of electrically insulating diamond-like carbon material having apertures therein which expose the electrically conductive material below so as to provide the one or more regions of electrically conductive diamond material for the analysis surface. In this embodiment the diamond-like carbon layer may typically have a thickness in the range 1 μm to 3 μm.

The apertures in the thin layer of diamond-like carbon material in this embodiment expose the electrically conductive diamond material below so that the electrode points are slightly recessed below the surface of the electrically insulating layer. For optimum performance of the microelectrode the recess depth should not be too great, but it can be larger when the electrode points have a larger diameter. For example, the electrode points may have an average diameter 15 to 20 times the thickness of the diamond-like carbon layer. Typically, the electrode points may have a diameter in the range 15 μm to 30 μm.

If desired the electrically insulating diamond-like carbon can be deposited so that it surrounds and insulates the edges of the conductive diamond substrate as well as providing a layer thereon. This helps to ensure that the conductive substrate will be insulated from other parts when mounted in a housing, for example even if mounted through a brazed joint.

The microelectrode of the present invention can be incorporated in a sensor for monitoring one or more characteristics of a fluid. The sensor will include at least one microelectrode which is connected to an external circuit adapted to convert electrical signals from the microelectrode into a qualitative or quantitative measure of the one or more characteristics of the fluid.

Microelectrodes of the present invention can be used to measure a variety of characteristics of fluids in various environments. For example, they can be adapted to sense pH, to detect the presence or absence of certain chemical species e.g. hydrogen sulphide or to measure the resistivity of the fluid. As both diamond and the diamond-like carbon are biocompatible they can be used to measure or monitor characteristics inside the human body. An analysis surface for a microelectrode can be made as small as 20 μm diameter, particularly if only one region of electrically conductive diamond material is required, and in this case the microelectrode can be mounted within a medical needle, which may have an internal diameter of 1 mm, and so inserted into the human body to take a measurement.

For some applications it may be desirable for the microelectrode to have an analysis surface which presents conductive regions of a particular material other than electrically conductive diamond, such as a metal like gold or platinum. The skilled person will appreciate that this can be achieved for the present invention by first providing an analysis surface having regions of electrically conductive diamond material and subsequently applying metal to the conductive regions by electroplating.

Microelectrodes according to the present invention can be made by any suitable method.

For example, one method suitable for making a microelectrode according to the first embodiment described above includes the steps of:

providing a substrate of electrically conductive diamond material,
selectively removing material from a face of that substrate so as to leave one or more protrusions projecting from the face,
depositing on to the face a layer of diamond-like carbon material so as to cover the one or more protrusions projecting therefrom, said diamond-like carbon material having
(a) a hardness that is lower than that of the electrically conductive diamond material, and
(b) a resistivity of at least 1×10⁹ ohmcm,
and then,
abrading the exposed surface of the layer of diamond-like carbon material until at least one of the previously-covered protrusions is exposed,
thereby providing an analysis surface for the microelectrode which analysis surface comprises one or more regions of electrically conductive diamond material surrounded by electrically insulating diamond-like carbon material.

Electrically conductive diamond material may be selectively removed from a face of the substrate by any suitable means, such as laser ablation using a UV laser or etching, for example by an argon chlorine etch such as that described in WO2008/090511.

Deposition of the diamond-like carbon material may be carried out by plasma assisted chemical vapour deposition in a vacuum chamber. The substrate of electrically conductive diamond material is placed on a cathode in the chamber which is capacitatively coupled to a radiofrequency source. A gas which is a source of carbon and hydrogen, such as acetylene, is introduced into the chamber and ionised by the field. Positive ions of carbon and hydrogen are attracted to the cathode and so bombard the substrate and deposit the diamond-like carbon on it. Unlike chemical vapour deposition of diamond (which normally takes place at about 800° C.) this process can take place near room temperature without the need for heating.

Abrasion of the diamond-like carbon material may be carried out by any suitable abrasive, such as diamond, silicon carbide or cubic boron nitride. By choosing an abrasive with a hardness between that of the diamond and the diamond-like carbon, the diamond-like carbon material will be fairly easily removed, but when the abrasive meets the electrically conducting diamond it will not be able to abrade that as effectively and so the rate of abrasion will slow providing the skilled person with a signal that enough material has been abraded away.

The operation of a microelectrode can be modelled more easily when the electrode points are present in a substantially flat surface. Accordingly, when making the electrode by the method described above, the layer of diamond-like carbon will often be deposited sufficiently thickly over the undulating surface of the electrically conductive diamond material to fill completely the depressions between the protrusions so that, after abrasion to expose protrusions, the analysis surface produced is substantially flat. However, it is not essential that the depressions are always completely filled as some undulation in the finished analysis surface will not affect the useful operation of the microelectrode as will be understood by the skilled addressee.

A microelectrode according to the second embodiment described above may be made, for example, by a method which includes the steps of providing a substrate of electrically conductive diamond material, depositing over that substrate a layer of electrically insulating diamond-like carbon material, the diamond-like carbon material having

(a) a hardness that is lower than that of the electrically conductive diamond material, and
(b) a resistivity of at least 1×10⁹ ohmcm,
and then,
selectively removing material to form one or more apertures in the layer of diamond-like carbon material and so expose electrically conductive diamond material below, thereby providing an analysis surface for the microelectrode which comprises one or more regions of electrically conductive diamond material surrounded by electrically insulating diamond-like carbon material.

In this method the electrically insulating diamond-like carbon material may be selectively removed by etching, laser ablation or any other suitable technique. Etching of the diamond-like carbon material may be carried out by known techniques. For example, plasma etching to selectively remove material to form apertures may be carried out through a lithography mask, resist or metal mask, which may be removed after the etch. Laser ablation of the diamond-like carbon material may be carried out by directly writing the laser onto its surface only in the regions where the apertures are desired. Alternatively a laser impermeable mask may be applied to the surface leaving apertures in the desired places so that when a laser scans the surface it can only remove diamond-like carbon material from those places. After the ablation step any mask may be cleaned from the surface. Conveniently the laser may be a UV laser but other light of other wavelengths may be also used.

A microelectrode according to the second embodiment may also be made by providing a substrate of electrically conductive diamond, partially masking the surface of that material with one or more obstructions, depositing over the substrate a layer of electrically insulating diamond-like carbon material and then removing the one or more obstructions to expose electrically conductive diamond material below.

The skilled person will appreciate that as the methods described for the second embodiment do not involve an abrasion step they can also be used for making a microelectrode which comprises any other type of electrically insulating material layer on a substrate of electrically conductive diamond material even one with a hardness equivalent to that of the electrically conductive diamond material, such as, electrically insulating diamond material. Accordingly in a third embodiment, the invention comprises a microelectrode having an analysis surface which comprises one or more regions of electrically conductive diamond material surrounded by electrically insulating diamond material having a resistivity of 1×10⁹ ohmcm or more, and the microelectrode being provided with connection means for electrically connecting the one or more regions to an external circuit, wherein the analysis surface is provided by a layer of electrically insulating diamond material deposited on a substrate of electrically conductive diamond material, the layer of electrically insulating diamond material having apertures therein which expose the electrically conducting material below so as to provide the one or more regions of electrically conducting diamond material for the analysis surface.

### BRIEF DESCRIPTION OF THE FIGURES

The invention will now be described by way of example with reference to the following drawings in which:

FIGS. 1a to 1c show sectional views through a microelectrode according to a first embodiment of the invention at different stages of its manufacture;

FIG. 1d shows a sectional view though another microelectrode made in the same way;

FIGS. 2a to 2c show sectional views through a microelectrode according to a second embodiment of the invention at different stages during its manufacture;

FIGS. 3a and 3b show plan views of two stages in the production of an analysis surface of an example of a microelectrode according to the present invention which comprises four arrays; and

FIG. 4 shows a plan view of the analysis surface of another example of a microelectrode according to the present invention which incorporates a reference electrode, counter-electrode and working electrode.

### DETAILED DESCRIPTION OF THE INVENTION

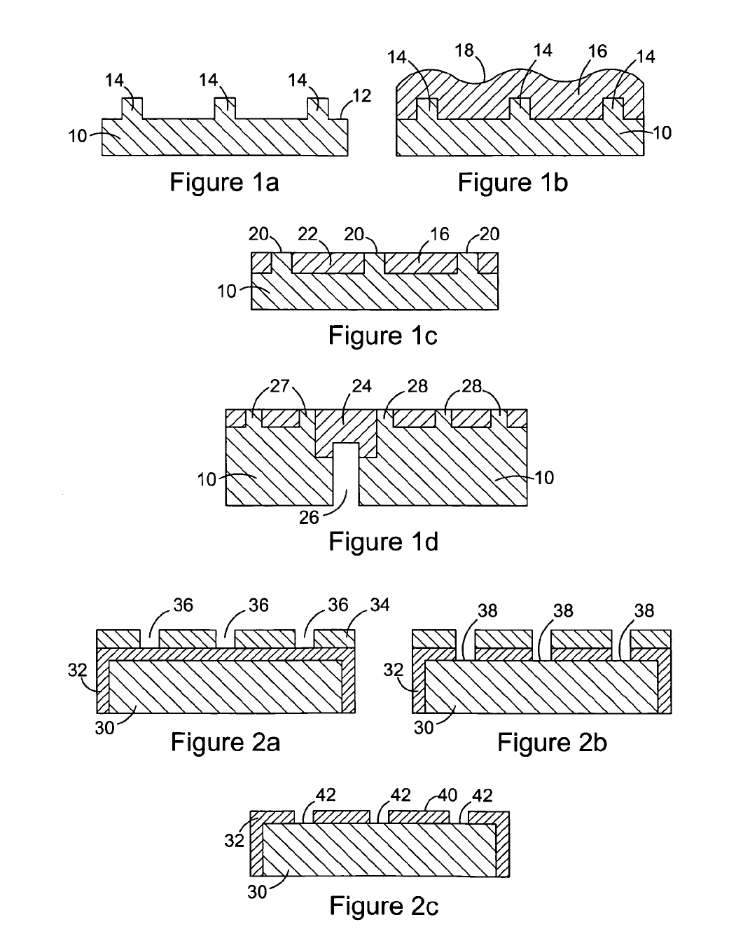

Referring to the drawings, FIG. 1a shows a substrate of electrically conductive diamond material 10 which has had material selectively removed from the face 12 so as to leave three protrusions 14 projecting forward from that face. In FIG. 1b the same substrate 10 is shown after a layer of electrically insulating diamond-like carbon material 16 has been deposited thereon so that it covers the protrusions 14. Subsequent abrasion to the exposed upper face of the layer of diamond-like carbon material 18 will remove material and this can be continued until the ends 20 of the previously covered protrusions 14 are exposed as shown in FIG. 1c. The ends 14 thereby provide regions of electrically conductive diamond material 10 surrounded by electrically insulating diamond material 16 in an analysis surface 22. The electrically conductive substrate 10 provides connection means for electrically connecting the regions together and to an external circuit.

FIG. 1d shows a microelectrode made in the same way but in which material was selectively removed to a greater depth in one section 24 of the electrically conductive substrate before the electrically insulating material was deposited. A channel 26 has also been cut through the electrically conductive substrate 10 into this section 24, for example by laser cutting. This has the effect of electrically separating some electrically conductive regions 27 from other regions 28. In such a way a microelectrode may be made in which the analysis surface is subdivided into two or more arrays which are electrically separated from each other. Each part of the divided conductive substrate 10 may be connected to a separate external circuit. If desired, before connection to the external circuit, the base of the substrate 10 may have been planarised to remove unnecessary back bulk.

Typically before processing the substrate 10 of electrically conductive diamond material will have a thickness 0.5 mm or less. Material may then be removed by etching or laser ablation to leave protrusions 14 with a height of 10 μm or more, conveniently about 50 μm. If during processing it is desired to remove excess back bulk of the substrate 10 this may be planarised down to the desired thickness, which may be as little as 50 μm (measured from base of substrate to base of protrusions).

FIG. 2a shows a substrate of electrically conductive diamond material 30 with a thin layer of electrically insulating diamond-like carbon material 32 deposited on top and around the sides. Over this is laid a resist mask 34 with apertures 36 therein. Subsequent treatment with an etch selectively removes diamond-like carbon material to form corresponding apertures 38 in the layer 32 and expose electrically conductive diamond material below, see FIG. 2b. The resist is removed from the layer 32, for example using a resist remover such as sodium hydroxide solution, to leave an analysis surface 40 with slightly recessed regions of electrically conductive diamond material 42 surrounded by electrically insulating diamond-like carbon material, see FIG. 2c.

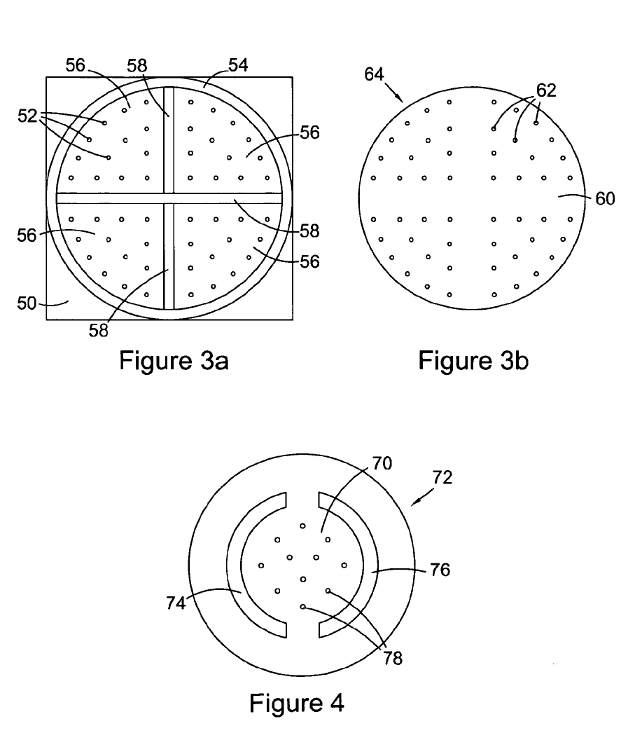

FIG. 3a shows a plan view of a substrate of electrically conductive diamond material 50 which has been etched back so that pillars of electrically conductive diamond 52 protrude upwards from it. A circular channel 54 has been etched more deeply into the diamond material 50 to enclose the pillars 52 and this has been divided into four quarters 56 by two grooves 58 which are not etched quite as deeply as the circular channel 54.

After deposition of a layer of electrically insulating diamond-like carbon material 60 to cover the pillars, that layer is abraded to reveal electrode points 62 as shown in FIG. 3b.

The structure has been planarised from below until the circular channel 54 is reached thereby cutting the microelectrode away from surrounding material to leave a microelectrode disc 64. Subsequent cutting of two grooves into the rear in the same positions as before has had the effect of electrically isolating the four quarters into four separate arrays. These arrays can then be electrically connected to separate electric circuits as desired. One convenient way to facilitate electrical connection to the arrays is to metallise the exposed surface of the layer of electrically conductive diamond material and then bond wires to the metallised surface.

A further embodiment of the invention is illustrated in FIG. 4. In electrochemical systems it is sometimes required to incorporate two or more types of electrode in the same microelectrode. These types of electrode may be differentiated for example by the voltage applied to them, by the use made of them in external circuitry, or by the geometry or size of the electrodes. FIG. 4 illustrates the analysis surface 70 of a microelectrode 72 that incorporates three electrodes: the reference electrode and positive and negative electrodes, generally known as the working electrodes (one of which may also be referred to as the counter-electrode). The analysis surface 70 comprises one crescent-shaped region of electrically conductive diamond material 74 which provides the reference electrode, a second crescent-shaped region of electrically conductive material 76 which provides the counter-electrode and an array of circular electrode points 78 located within the area enclosed by the crescent-shaped regions 74, 76 and which are electrically connected together below the analysis surface to provide the other working electrode. Below the analysis surface the geometry of the microelectrode is such that the three electrodes are electrically separated from each other, for example by channels or grooves cut through into the layer of electrically conductive diamond material in similar manner to that discussed for FIG. 1d. It will be understood that if desired the array of electrode points 78 in such a microelectrode may also be further subdivided into different addressable areas.

1. A microelectrode having an analysis surface which comprises one or more regions of electrically conductive diamond material surrounded by electrically insulating diamond-like carbon material, the diamond-like carbon material having
(a) a hardness that is lower than that of the electrically conductive diamond material, and
(b) a resistivity of at least 1×10⁹ ohmcm,
and the microelectrode being provided with connection means for electrically connecting the one or more regions to an external circuit.

2. A microelectrode as claimed in claim 1 wherein the electrically conductive diamond material comprises boron doped diamond.

3. A microelectrode as claimed in claim 1 wherein the diamond-like carbon material has a hardness less than or equal to 0.6 times the hardness of the electrically conductive diamond material.

4. A microelectrode as claimed in claim 1 wherein the analysis surface comprises two or more regions of electrically conductive diamond material surrounded by electrically insulating diamond-like carbon, which regions are electrically connected to each other at a position away from the analysis surface.

5. A microelectrode as claimed in claim 1 wherein at least one of said regions of electrically conductive diamond material has a diameter in the range 15 μm to 30 μm.

6. A microelectrode as claimed in claim 1 wherein the analysis surface comprises an array of three or more regions of electrically conductive diamond material surrounded by electrically insulating diamond-like carbon each such region having a diameter in the range 15 μm to 30 μm and being separated from its nearest neighbours by a distance of 5 to 15 times the average diameter of the regions, and which the regions are electrically connected to each other at a position away from the analysis surface.

7. A microelectrode as claimed in claim 6 in which the analysis surface is subdivided into two or more arrays which are electrically separated from each other and adapted to connect to separate external circuits.

8. A microelectrode as claimed in claim 1 which comprises a layer of electrically insulating diamond-like carbon material deposited on a substrate of electrically conductive diamond material, the substrate of electrically conductive diamond material having one or more protrusions projecting through the layer of diamond-like carbon material so as to provide the one or more regions of electrically conductive diamond material for the analysis surface.

9. A microelectrode as claimed in claim 8 wherein the diamond-like carbon layer has a thickness in the range 5 μm to 10 μm.

10. A microelectrode as claimed in claim 1 in which the analysis surface is provided by a layer of electrically insulating diamond-like carbon material deposited on a substrate of electrically conductive diamond material, the layer of electrically insulating diamond-like carbon material having apertures therein which expose the electrically conducting material below so as to provide the one or more regions of electrically conducting diamond material for the analysis surface.

11. A microelectrode as claimed in claim 10 wherein the diamond-like carbon layer has a thickness in the range 1 μm to 3 μm.

12. A microelectrode as claimed in claim 11 in which the one or more regions have an average diameter from 15 to 20 times the thickness of the diamond-like carbon layer.

13. A sensor for monitoring one or more characteristics associated with a fluid, the sensor comprising at least one microelectrode as claimed in claim 1 which is connected to an external circuit adapted to convert electrical signals from the microelectrode into a qualitative or quantitative measure of the one or more characteristics.

14. A method of making a microelectrode which includes the steps of:
providing a substrate of electrically conductive diamond material;
selectively removing material from a face of that substrate so as to leave one or more protrusions projecting from the face;
depositing on to the face a layer of diamond-like carbon material so as to cover the one or more protrusions projecting therefrom, said diamond-like carbon material having
(a) a hardness that is lower than that of the electrically conductive diamond material, and
(b) a resistivity of at least 1×10⁹ ohmcm,
and then,
abrading the exposed surface of the layer of diamond-like carbon material until at least one of the previously-covered protrusions is exposed, thereby providing an analysis surface for the microelectrode which analysis surface comprises one or more regions of electrically conductive diamond material surrounded by electrically insulating diamond-like carbon material.

15. A method of making a microelectrode which includes the steps of providing a substrate of electrically conductive diamond material, depositing over that substrate a layer of electrically insulating diamond-like carbon material, the diamond-like carbon material having
(a) a hardness that is lower than that of the electrically conductive diamond material, and
(b) a resistivity of at least 1×10⁹ ohmcm,
and then,
selectively removing material to form one or more apertures in the layer of diamond-like carbon material and so expose electrically conductive diamond material below, thereby providing an analysis surface for the microelectrode which comprises one or more regions of electrically conductive diamond material surrounded by electrically insulating diamond-like carbon material.

16. A method as claimed in claim 15 in which material is selectively removed from the layer of diamond-like carbon by etching or laser ablation.

17. (canceled)
